(19) United States
(12) Patent Application Publication
(10) Pub. No.: US 2019/0005167 A1
(43) Pub. Date: Jan. 3, 2019

(54) Method for Synchronizing a Plurality of Simulations

(71) Applicant: Siemens Aktiengesellschaft, Muenchen (DE)

(72) Inventor: Beat Laemmle, Abenberg (DE)

(21) Appl. No.: 16/020,285

(22) Filed: Jun. 27, 2018

(30) Foreign Application Priority Data
Jun. 29, 2017 (EP) 17178612.2

(51) Int. Cl. G06F 17/50; G06F 9/52; G06F 9/54

(52) U.S. Cl. CPC G06F 17/5009; G06F 9/542; G06F 9/52

(57) ABSTRACT

A method for synchronizing a plurality of simulations executed by respective simulation programs, an associated computer program product and an associated coordination unit, wherein a plurality of simulations executed by respective simulation programs are synchronized, and wherein the following steps are performed by a coordination unit, i.e., determination of respective status messages of the simulation programs for the completed run through a given cycle, where for each simulation an associated cycle is established by a respective sequence via the respective simulation program of logic steps to be executed, and where outputting in each case of a synchronization message to one or more of the simulation programs, if the respective status messages of the plurality of simulations are present, such that each synchronization message triggers a start of a following cycle of the respective simulation program.

### BACKGROUND OF THE INVENTION

### 1. Field of the Invention

The invention relates to a method for the synchronization of a plurality of simulations executed by respective simulation programs, an associated computer program product and an associated coordination unit.

### 2. Description of the Related Art

In industrial automation, such as in industrial production, simulation processes are of enormous importance. Processes or sequences of production steps or transport processes or commissioning of machines or performance of production steps are simulated to be able to establish in a virtual environment whether unexpected faults or reactions or complications will occur. Based on results usually of a plurality of simulations, a virtual reproduction of a process is achieved. This kind of virtualization of individual sequences in an industrial environment facilitates planning and enables early identification of incorrect adjustments, faulty parameterizations, faulty wiring or faulty designs. It is thus possible, for example, even in advance, such as in the case of simulated and virtual commissioning, to establish a fault that may be present, which can be removed before risks due to a non-functioning plant or costs due to the destruction of plant parts occur.

The possibilities of simulations are increasingly far-reaching. Increasingly complex calculations for the simulation and increasingly precise predictions in the interaction between, for example, individual plant parts or components of a plant are possible. Individual partial aspects or individual automation sub-steps are simulated, which in reality have dependences. For example, processes occur in reality simultaneously with one another or have a dependence on one another at a point in time in the process. For example, input data that are generated by another process are processed at a point in the production sequence.

The possibility of synchronization is thus required between different processes actually taking place. A simulation that comprises a plurality of sub-simulations should also be able to be coordinated. Particularly, for complex simulations an entire simulation is broken down into many parallel simulations, which are to be processed in parallel with one another. The different sub-simulations influence the final or overall simulation. As a result, a synchronization of these sub-simulations is required.

The synchronization of simulations that are implemented in software, but occur in different processes or on different computers, is necessary for uniform progress of the simulations and a correct simulation as a whole. Simulations are usually executed too quickly or too slowly on simulation tools, i.e., in software. For the consideration of a single simulation, this is not usually critical, if a mapping factor between real time and virtual time can be determined and can thus be taken into account. This is not, however, non-critical for a plurality of dependent simulations. In addition, there is the fact that simulations are not usually executed equally quickly or slowly. Depending on the complexity, which can be extended or reduced by logic junctions within a simulated process, the rapidity of a simulation changes. Furthermore, an available computing capacity can influence the simulation times, such as in the case of a plurality of simulations occurring on one computer.

An approach to a solution, which aims to permit a specific real time to be simulated by a simulation program, irrespective of the time required for this, often fails due to the fact that many simulations do not comprise this functionality. This is due, for example, to the fact that, during the course of a simulation, the system cannot be verified how much time has elapsed. For example, a Programmable Logic Controller (PLC) can only check at the end of the cycle, i.e. afterwards, whether a defined time has been exceeded.

On account of the irregularity in the required simulation time for a defined simulated time, the execution of program codes also requires a different amount of time depending on the simulated program.

Solutions that use a virtual time are known. Simulations to be synchronized are configured such that, with regard to the running time, they agree on a factor for determining the virtual time. Simulations are thereby slowed down in some cases, such that all the simulations are completed in good time. The simulations run in an uncoordinated manner. Rapidly running simulations wait for the slowest simulation and the retarded speed thus applied to most of the simulations therefore slows down the individual simulation processes and possibly occupies computing capacity. Moreover, simulations may be dealing with incorrect data, if there are dependences between the individual simulations.

In another scenario, a time slice is allocated to the simulations one after the other, and a wait occurs to see how much time the currently running simulation has actually simulated. The already elapsed time can then be set off in time slices of the following simulations. A drawback is a greatly lengthened running time, because only one simulation is working at each point in time.

### SUMMARY OF THE INVENTION

With the foregoing in mind, it is therefore an object of the present invention to provide an improved synchronization of a plurality of simulations and at the same time efficient processing of the simulations.

These and other objects and advantages are achieved in accordance with the invention by a method for synchronizing a plurality of simulations executed by respective simulation programs, where the steps of the method are performed by a coordination unit, i.e., determining respective status messages of the simulation programs for a completed run through a given cycle, where for each simulation an associated cycle is established by a respective sequence via a respective simulation program of logic steps to be executed, and outputting a synchronization message to one or more of the simulation programs in each case, if the respective status messages of the plurality of simulations are present, wherein the synchronization message triggers a start of a following cycle of the respective simulation program.

A synchronization occurs based on cycles. A cycle is established by a sequence of logic steps, which are to be executed by a simulation program. It thus involves a section of a program that particularly represents a logically completed program sequence. For example, precisely one simulation step is calculated in a cycle. This does not involve a time interval defined by a time elapsing in real or virtual terms. Neither is a time, which is actually required for a simulation, defined by a cycle, nor is the time interval that is to be simulated by a simulation program defined.

A cycle synchronization is thus achieved. Status messages of the simulation programs indicate whether a cycle has been terminated. A completed run through a cycle is thus reported to the coordination unit. The coordination unit receives and determines respective status messages and is thus informed as to which of the plurality of simulations have calculated a cycle to the end. With the coordination unit, outputting of a synchronization message occurs if the status message of the simulation to be synchronized is present in each case. Synchronization message means that a message is transmitted to the individual simulations, which in each case triggers a start of a following cycle in the respective simulation program.

All the simulations are thus made aware of the fact that all the other simulations have also processed their cycle. Even the slowest, i.e. the simulation taking longest in real-time, is completed and ready for the next cycle when the synchronization message is sent. The cycle is thus calculated in an optimum manner with the highest possible repetition rate for each simulation program, and the synchronization of the simulations is simultaneously ensured.

A cycle in which, for example, a loop is processed in the program-related sense, or a sequence is processed, can prove to be more or less complex. A step to be simulated in a process sequence can prove to be of varying complexity due, for example, to variable inputs or dependences on ambient conditions. For example, a more complicated or less complicated simulation algorithm is retrieved depending on user data or depending on an external influence on a process by another process or by ambient conditions. For example, this more complicated algorithm requires a longer time to calculate the cycle than in the case of other input variables influencing the simulation, such as other user data or ambient conditions.

Simulations which have finished calculating their cycle more quickly than others are slowed down by the wait for the synchronization message, before the next simulation cycle starts. Slowing-down of faster simulations for synchronization with slower simulations thus advantageously occurs without a virtual time having to be introduced or even a virtual speed of the time. Fast simulations can advantageously calculate their cycle as fast as possible and are available for other processes during the waiting time. This optimizes the load on the computing capacity. It is advantageously not necessary for a manual adjustment of the speed of the time to be implemented in the case of a plurality of simulations that are to be synchronized by a common virtual time concept. Each simulation would have to be separately adapted by way of a factor, and this possibly also during the running time, if the speed of the virtual time changes. Neither is a time concept actually needed, nor do the simulations have to agree on a common time concept. Especially for simulations that have or recognize no time concept and work only in cycles and in particular must always finish calculating a cycle, the solution represents an advantageous option for synchronization with other simulations based on the cycle concept.

A cycle is established, for example, by the fact that a plurality of parallel simulations have processed a program sequence, after which a data exchange is provided for. The end of a cycle can be defined, for example, by a point in the program sequence at which the data exchange is to occur in the real process.

The respective definition of a cycle of different simulations to be synchronized may be the same as one another or different from one another. For example, the definitions of respective cycles of different simulations correspond with one another. It is, however, just as possible to incorporate a transformation ratio. For example, if a simulation, in one of its cycles, processes aggregated data of another simulation from three cycles for example, the ratio is 3:1.

The presented synchronization based on the cycles is advantageously independent of whether a speed of the simulated time is uniform or remains uniform. It is of no importance for the synchronization message which simulation of the plurality of simulations requires the longest time to calculate its cycle. The slowest simulation is always awaited and only then is the synchronization message output.

The coordination unit acts as a master for a start of a cycle. At this point, which can be provided centrally or decentrally, the progress of the respective simulation is defined as the master for all the simulations to be synchronized.

In accordance with an embodiment, the respective cycles are constituted differently depending on the sequence of the given simulation program. For example, the definition of a cycle remains the same, the cycle or the processing of the cycle however turns out differently within this definition, such as depending on influences from other simulations. In particular, a cycle, considered over time, lasts for different lengths of time.

In accordance with an exemplary embodiment, output of the respective synchronization message is only possible when the status messages of all the simulation programs to be synchronized have been ascertained. It is thus ensured that no simulation program starts a following cycle for as long as all the others have not completed the current cycle.

In accordance with an embodiment, the coordination unit exchanges data via a bidirectional communication channel with the respective simulation programs. It is, for example, a pipe mechanism, i.e., a bidirectional, serial communication channel between two end points. This mechanism is provided by the operating system of a computer unit upon which the simulation programs are running. Advantageously, the operating system can allocate freed-up resources for waiting simulation programs to another process.

In accordance with an embodiment, the respective status messages from the respective simulation programs are received via the bidirectional communication channel by the coordination unit. A pipe mechanism of an operating system can advantageously be used for the transmission of status messages.

In accordance with another embodiment, the respective synchronization messages are sent by the coordination unit via the bidirectional communication channel to the respective simulation programs. The pipe of an operating system is advantageously also used for the transmission of the synchronization messages. As an alternative to a pipe mechanism, transmissions of synchronization messages and status messages are also conceivable via a network. Especially in cases in which a plurality of simulations are running on one computer and in addition further simulations on another computer and a coordination unit is provided on one of the two computers as a coordination unit and master for all the simulations, network connections can advantageously be used.

In accordance with a further embodiment, the coordination unit ascertains respective cycle counter information for each simulation program. For example, each simulation reports to the coordination unit with its current cycle counter. This takes place, for example, during the start-up or starting of a simulation or during integration of an additional simulation to a quantity of existing simulations. Different simulations to be synchronized can report to the coordination unit at points in time diverging from one another and can start their respective simulation. In particular, it is not therefore necessary for it to be clear or established in advance which simulations are ultimately to be synchronized with one another. Even large time intervals between the starting time of different simulations can be taken into account by the coordination unit through the knowledge of the cycle counter status. Stopping of the further simulations to be synchronized until a uniform cycle counter status is present with all the synchronizations is also conceivable as a way of taking account of the cycle counter differences at the time of a simulated synchronization.

In accordance with an embodiment, in conjunction with the synchronization message or before processing of the synchronization message, updated input data or a notification of updating of input data are mutually made available to the simulation programs by the coordination unit or by the simulation programs. Before the synchronization message is sent, the coordination unit can, for example, provide new input data to the respective simulation programs. These input data can be created or influenced by current simulated output data of other simulations. These input data can also be mutually exchanged among the simulation programs. In the latter case, it should however be ensured that processing or analysis of the input data does not occur until the synchronization message has been output. Apart from the transmission of the updated input data themselves, a transmission of a notification concerning this updating of the input data is also conceivable. The notification can thus occur that a simulation has the correct input data present. Advantageously, the data exchange can take place during the pause after completion of all the cycles and before the start of the next cycle.

The real data exchange can also be mapped as a separate simulation. At this point, the cycle counter information can also be taken into account for the simulation of the data exchange.

In accordance with yet another embodiment, a cycle is allocated for each simulation, in particular by the respective simulation program or the coordination unit. For example, it is set in each individual simulation as to when this individual simulation considers its cycle completed. For example, a set cycle of the bus connected to the PLC is selected by a simulation program for the simulation of a programmable logic controller (PLC). For the simulation of a mechanical system, the cycle is set, for example, in the settings of the simulation. For simulations of a drive or process, a user sets a cycle for the calculation. Simulations are thus able with their own mechanisms to define the cycle through the user. Advantageously, an individual simulation does not necessarily have to know which other simulations it is being synchronized with or will be synchronized with.

It is also an object to provide a computer program product including a computer program, which comprises means for performing the method described above when the computer program is executed on a program-controlled device.

It is also an object to provide a coordination unit on a computer, where the coordination unit is configured to perform the method steps in accordance with the above-described method and where the coordination unit when connected is capable of communication to the simulation programs.

In accordance with an embodiment, the coordination unit on the computer is executed jointly with one or more of the simulation programs.

In accordance with another embodiment, the plurality of simulation programs are executed on one or more separate computers.

It is also an object of the invention to provide a computer program product including a computer program, which comprises means for performing the method above-described when the computer program is executed on a program-controlled device.

A computer program product, such as a computer program means, can for example be made available or delivered as a storage medium, such as a memory card, USB stick, CD-ROM, DVD, or also in the form of a downloadable file from a server in a network. This can occur, for example, in a wireless communication network by the transmission of a corresponding file with the computer program product or the computer program means. As a program-controlled device, a control device in particular comes into consideration, such as a processor or a microprocessor. A processor is understood to mean an electronic circuit for computer-based data processing, such as a CPU. It may be the CPU of a computer or a microprocessor of a microchip.

The coordination unit can be implemented hardware-based and/or software-based. In the case of a hardware-based implementation, the coordination unit can be form a device or part of a device, such as a computer or a processor or a microprocessor. In the case of a software-based implementation, the respective unit can comprise a computer program product, a function, a routine, part of program code or an executable object.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is explained in greater detail below on the basis of examples of embodiment with the aid of the figures, in which:

FIG. 1 shows a flowchart of the method in accordance with an exemplary embodiment of the invention; and

FIG. 2 shows a diagrammatic representation of ongoing simulation cycles over time so as to illustrate a cycle synchronicity.

### DETAILED DESCRIPTION OF THE EXEMPLARY EMBODIMENTS

To illustrate the present invention, a process for slowing down a drive for a production machine, which is to be simulated, is taken by way of example as a basis. The drive should operate with a definable and adaptable speed for the normal operation and, after the initiation of a stopping procedure, the speed should be reduced in accordance with a selected stop mode. In the simulation of such a process, a multiplicity of processes taking place have to be simulated and coordinated with one another. The simulation of the mechanical braking process and of a user input possibly occurring and interventions in the braking process triggered by a movement control are to be considered. Three simulations result, for example, for such a scenario, i.e., one for the control, one for the drive and one for the mechanical system. Simulations mutually influencing one another are to be executed such that a synchronization occurs between them. Thus, the sub-simulations can have access to current data of other sub-simulations.

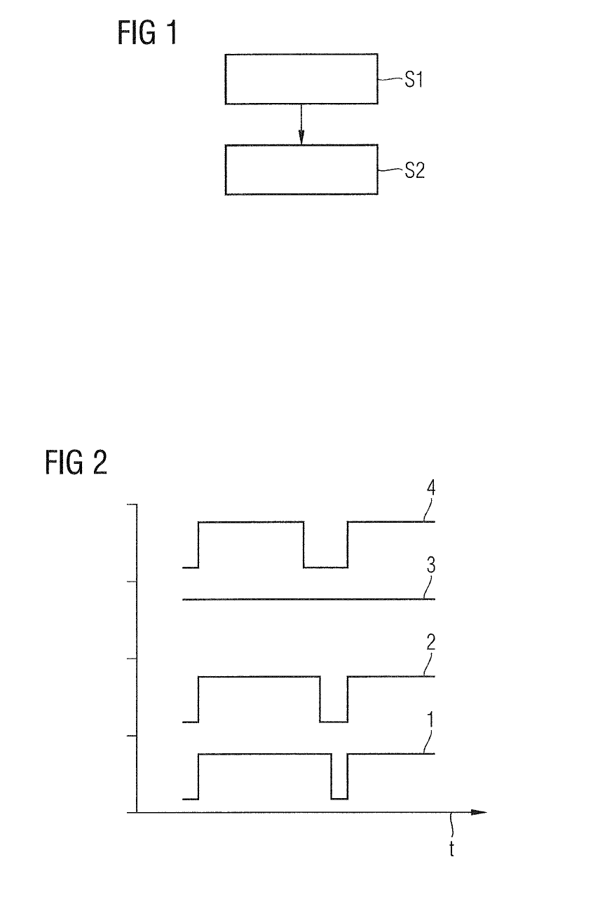

FIG. 1 shows the essential method steps taking place, determination S1 of status messages of the simulation programs and output S2 of a synchronization message to the simulation programs. These steps are performed by a coordination unit or coordination point which, when connected, is capable of communication to the simulation programs. This coordination unit functions as a master with regard to the start of new simulation cycles. A simulation cycle is formed, for example, by the processing of a program code, which simulates a specific function. The number of program code lines that have to be executed for this can often change arbitrarily. For example, the triggering of a not-stop is simulated, where different reactions are triggered depending on an assumed movement of a hand in the vicinity of a production machine.

For the determination of the simulation result of the speed setting, for example, apart from taking account of the predictable influences remaining relatively constant due to the simulation of the movement control, account must also be taken of the irregular and fluctuating input data due to the simulation of a user input process. The synchronization of the different processes should therefore precisely not be established based on the computing time actually required for a simulation and also not on the basis of a defined time to be simulated. Instead, the processing of cycles and the ending of cycles is used as a trigger for a synchronization.

Determination S1 of status messages of the simulation programs to be synchronized occurs in the present example by the evaluation of received status messages by the coordination unit. The different simulations send their status message to the coordination unit when their cycle has been run through. The status message thus contains, by way of example, the statement “cycle simulation 01 calculation completed”.

The coordination unit initiates the step of outputting S2 synchronization messages to all the simulation programs to be synchronized when the respective status messages of all the simulations are present. The slowest-running simulation has thus also been taken into account by the coordination unit and the start of the next cycle is performed in the various simulations synchronously coordinated with one another.

To illustrate the synchronization effect that is achieved by the present invention, FIG. 2 shows by way of example four simulations in a diagram plotted above one another and over time. A course of the respective simulation curve at the low value in each case indicates the periods in which a cycle has finished being computed and the next one has not yet begun, the periods in which a respective simulation curve 1, 2, 3, 4 runs at a higher level shows the phases of the ongoing simulation of the cycle. The joint simultaneous start of the three simulations 1, 2 and 4 can be seen at time t. These three simulations 1, 2, 4 start a new cycle. Simulation 3 also starts its cycle. This cycle is consistent as the slowest simulation in the computing of cycles. The pause between one cycle and the following cycle is not represented in this representation. Embodiments are also conceivable, in which all four simulations 1, 2, 3, 4 have a short mutual pause and together start a following cycle. The illustrated embodiment is the most efficient with regard to the computing time required for the simulations.

Simulations advantageously access current data of other simulations and at the same time all the simulations compute in parallel with the maximum possible speed. Times in which computing capacity is not required for the simulation in a simulation program are used by other processes. A computer with a plurality of cores is utilized in the optimum manner. Through the use of means of the operating system for the stopping of fast simulations, such as the above-described pipe, information is available to the operating system to supply the slower simulations with more computing time. It is thus not necessary to focus on a worst-case scenario in the configuration, but rather a flexible approach to the required computing capacity for each simulation can be taken.

Data from a simulation of, for example, a so-called PLC or programmable logic controller are integrated cycle-synchronized into another simulation, such as that of a controlled process, e.g., a production process.

Data transmissions also occurring in reality, such as via a hardware bus between a control and a drive, can be simulated and this simulation can be synchronized with other simulations. The control and drive communicate, for example, via various software and hardware layers. Both the hardware and also parts of the software layers are advantageously omitted in a simulation for reasons of speed and instead other communication means are used.

These other communication means form the simulation basis for the data exchange. The simulation of the data exchange can also implement a conversion of data formats, standardizations etc. and then simulate somewhat more than just the data exchange.

A manipulation of the time concept and, in general, the presence and knowledge of a time concept in different simulations is advantageously dispensed with. An advantageous effect of this is also that, for a simulation of a programmable logic controller, for example, a time which this control requires for its cycle can be assumed to be 0. If the speed of the time for the synchronization were used, this approach would fail, because the speed would be infinitely fast. The synchronization based on a time concept would therefore also fail. If, in special cases of application, a time concept of a simulation is required, for example time information of an application is to be made available as an output, a simulation can be calculated back for the time based on the separate cycle.

Although the invention has been illustrated and described more closely in detail by the examples of embodiment, the invention is not limited by the disclosed examples and other variations can be derived therefrom by the person skilled in the art without departing from the scope of protection of the invention.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for synchronizing a plurality of simulations executed by respective simulation programs, the method comprising:
determining, by a coordination unit, respective status messages of the respective simulation programs for a completed run through a given cycle, for each simulation an associated cycle being established by a respective sequence via the respective simulation program of logic steps to be executed; and
outputting, by the computation unit, in each case of a synchronization message to at least one of the simulation programs, if the respective status messages of the plurality of simulations are present, each synchronization message triggering a start of a following cycle of the respective simulation program.

2. The method as claimed in claim 1, wherein the respective cycles are constituted differently depending on a sequence of a given simulation program.

3. The method as claimed in claim 1, wherein output of the respective synchronization message is only possible when the status messages of all simulation programs to be synchronized have been ascertained.

4. The method as claimed in claim 2, wherein output of the respective synchronization message is only possible when the status messages of all simulation programs to be synchronized have been ascertained.

5. The method as claimed in claim 1, wherein the coordination unit exchanges data via a bidirectional communication channel with the respective simulation programs.

6. The method as claimed in claim 5, wherein the respective status messages from the respective simulation programs are received via the bidirectional communication channel by the coordination unit.

7. The method as claimed in claim 5, wherein the respective synchronization messages are sent by the coordination unit via the bidirectional communication channel to the respective simulation programs.

8. The method as claimed in claim 6, wherein the respective synchronization messages are sent by the coordination unit via the bidirectional communication channel to the respective simulation programs.

9. The method as claimed in claim 1, wherein the coordination unit ascertains respective cycle counter information for each simulation program.

10. The method as claimed in claim 1, wherein, in conjunction with the synchronization message or before processing of the synchronization message, one of (i) updated input data and (ii) a notification of updating of input data are mutually made available to the simulation programs by one of (i) the coordination unit and (ii) the simulation programs.

11. The method as claimed in claim 1, wherein a cycle is allocated for each simulation, in particular by the respective simulation program or the coordination unit.

12. The method as claimed in claim 11, wherein a cycle is allocated for each simulation by one of (i) the respective simulation program and (ii) the coordination unit.

13. A non-transitory computer program product encoded with a computer program which, when executed by program-controlled device, causes synchronization of a plurality of simulations executed by respective simulation programs comprises, the computer program comprising:
program code for determining, by a coordination unit, respective status messages of the respective simulation programs for a completed run through a given cycle, for each simulation an associated cycle being established by a respective sequence via the respective simulation program of logic steps to be executed; and
program code for determining, by a coordination unit, respective status messages of the respective simulation programs for a completed run through a given cycle, for each simulation an associated cycle being established by a respective sequence via the respective simulation program of logic steps to be executed.

14. A coordination unit on a computer, wherein the coordination unit is configured to:
determine respective status messages of the respective simulation programs for a completed run through a given cycle, for each simulation an associated cycle being established by a respective sequence via the respective simulation program of logic steps to be executed; and
output in each case of a synchronization message to at least one of the simulation programs, if the respective status messages of the plurality of simulations are present, each synchronization message triggering a start of a following cycle of the respective simulation program;
wherein the coordination unit is configured to communicate with the simulation programs.

15. The coordination unit as claimed in claim 14, wherein the coordination unit on the computer is executed jointly with at least one the simulation programs.

16. The coordination unit as claimed in claim 14, wherein the plurality of simulation programs are executed on one or more separate computers.
